(19) United States
(12) Patent Application Publication
(10) Pub. No.: US 2010/0098378 A1
(43) Pub. Date: Apr. 22, 2010

(54) OPTICAL DEVICE FOR STORAGE AND PRODUCTION OF ENERGY

(76) Inventor: Kimball John Norman, JR., McKinney, TX (US)

Correspondence Address: SPENCER, FANE, BRITT & BROWNE, 1000 WALNUT STREET, SUITE 1400, KANSAS CITY, MO, 64106-2140, US

(21) Appl. No.: 12/604,264

(22) Filed: Oct. 22, 2009

Related U.S. Application Data
(60) Provisional application No. 61/197,005, filed on Oct. 22, 2008.

(51) Int. Cl. G02B 6/42; G02B 6/02; G02B 6/00

(52) U.S. Cl. 385/31; 385/123; 385/141

(57) ABSTRACT

The present invention provides an optical device for inputting, producing, and storing energy. The device includes a core and a cladding surrounding said core, where the refractive index of the cladding is lower than the refractive index of the core. The device further includes at least one energy-capturing insert embedded in the core for capturing energy from the impact thereon of photons traveling through the core.

### CROSS REFERENCE TO RELATED APPLICATIONS

This Application claims priority of U.S. Provisional Application No. 61/197,005, filed on Oct. 22, 2008 and incorporated herein by reference in its entirety.

### STATEMENT REGARDING FEDERALLY SPONSORED RESEARCH AND DEVELOPMENT

None.

### BACKGROUND OF THE INVENTION

The Sun is the ultimate energy source for life on earth. Solar radiation constantly impacts the earth's surface and represents a vast and largely untapped resource for the production of useful energy. Devices for harnessing solar energy, such as photovoltaic cells, are known in the art. Such devices, however, are typically large and rely on a constant stream of solar radiation in order to continue to produce energy.

Fiber cables capable of transmitting light or other wavelength energy are also known in the art. These include, for example, fiber optic cables and plastic fiber cables. Such cables are small and light-weight, and are thus easily transported. By their nature, fiber cables trap light or wavelength energy within the boundaries of the cable.

The present invention provides a novel optical device for generating power from light or wavelength energy, such as from solar radiation or other sources, and for continuing to extract energy from these sources after the device has been removed from the source of the light or other wavelength energy.

### BRIEF SUMMARY OF THE INVENTION

The present invention provides an optical device for inputting, producing, and storing energy. The device includes a core and a cladding surrounding said core, where the refractive index of the cladding is lower than the refractive index of the core. The device further includes at least one energy-capturing insert embedded in the core for capturing energy from the impact thereon of photons traveling through the core.

Another aspect of the invention provides a fiber cable having at least one energy-capturing insert embedded in a core thereof for capturing energy from the impact thereon of photons traveling through the core.

In another aspect of the invention, the energy-capturing insert is a photovoltaic cell.

In still another aspect of the invention the photovoltaic cell is a thin film amorphous silicon photovoltaic cell.

In still another aspect of the invention, the present device further includes a lead extending from the energy-capturing insert to an exterior of said optical device for transmitting energy from the optical device to an energy-receiving device.

In another aspect of the invention, the fiber cable is a fiber optic cable or a plastic fiber cable.

Another aspect of the invention provides a method for producing and storing energy. The method includes the steps of providing a fiber cable adapted to receive wavelength energy, proving at least one energy-capturing insert within the cable, and introducing into the fiber cable wavelength energy from an energy source.

In another aspect of the method of the present invention, the steps further include providing a lead from the present invention to a device capable of receiving electrical energy, and transmitting electrical energy along the lead from the present device to the device capable of receiving energy.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention. Though some features of the invention may be claimed in dependency, each feature has merit when used independently.

### BRIEF DESCRIPTION OF THE DRAWINGS

Further features of the present invention will become apparent to those skilled in the art to which the present invention relates from reading the following description with reference to the accompanying drawings, in which:

FIG. 1a is a schematic diagram depicting a closed, continuous loop of fiber optic core in accordance with the principles of the present invention, the core having an energy-capturing insert embedded therein.

FIG. 1b is a schematic diagram depicting a straight length of fiber optic core in accordance with the principles of the present invention.

FIG. 2 is a schematic diagram depicting a closed loop of fiber optic core in accordance with the present invention, the core having an energy-capturing insert embedded therein and an energy insert lead associated therewith.

FIG. 3 is a schematic diagram depicting a closed loop of fiber optic core in accordance with the present invention, the closed loop of fiber optic core having an energy measuring device and related controls and instrumentation associated therewith.

FIG. 4 is a schematic diagram depicting three closed loops of fiber optic core in accordance with the present invention, the closed loops of fiber optic core being provided with energy from a single energy source.

FIG. 5 is a schematic diagram depicting a closed loop of fiber optic core of the present invention.

FIG. 6 is a schematic diagram depicting a closed loop of fiber optic core of the present invention having an energy receiving device and energy storing device associated therewith.

FIG. 7 is a schematic diagram providing a cross-section of a fiber optic cable of the present invention.

### DETAILED DESCRIPTION OF THE INVENTION

The invention will now be described with reference to the drawing figures, in which like reference numerals refer to like parts throughout. As used in the drawings, numeral 100 refers generally to an energy producing and storage device of the present invention, and numeral 111 refers generally to a looped fiber cable such as a fiber optic cable or plastic fiber cable. Numeral 108 refers to an energy-capturing insert embedded in a core 102 of cable 111 and having a lead 112 extending therefrom. Energy-capturing insert 108 is preferably energy-capturing along approximately one-half of each side, and reflective along approximately one-half of each side, so that energy impacting energy-capturing device 108 from either direction will be partially captured and partially reflected. It is contemplated, however, that one or both sides of energy-capturing insert 108 may be entirely energy-capturing, or may include surfaces that are energy-capturing along any suitable percentage of the surface area thereof. Numeral 113 refers to an energy insert fiber extending to the core 102 (shown in FIG. 9) of looped fiber cable 111 for delivering wavelength or other energy to device 100. Numeral 114 refers to a straight length of fiber cable having one or more energy-capturing inserts embedded therein and capable of receiving energy input from either end thereof. These and other numerals and their associated elements will be described with more detail below.

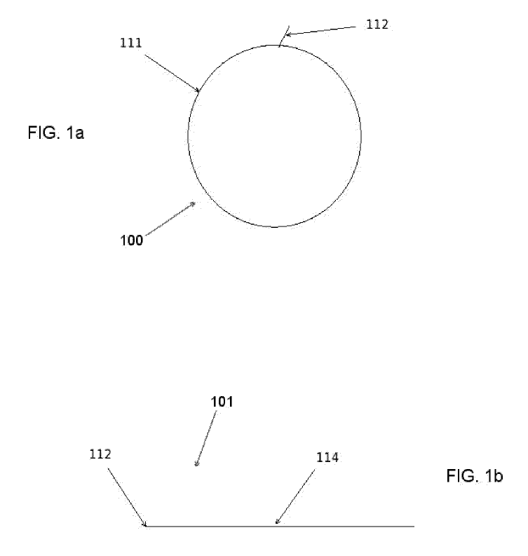

FIG. 1 is a schematic diagram depicting a looped fiber cable 111 approximately five inches in diameter (though any suitable diameter may be used) having an energy capturing insert 108 (shown in FIG. 9) embedded in the core 102 thereof (core 102 also being shown in FIG. 9, depicting the cross-sectional structure of fiber cable 111 and fiber cable 114). Looped fiber cable 111 may be constructed from glass, silica, plastic or other suitable material. For example, 1550-nm loss-minimized fiber may be used. Further, single mode optical glass fiber may be used, as well as step index or multiplex glass fiber. The general structure of fiber cables, including fiber optic cables, is known in the art and is not set forth in detail here. Energy capturing insert 108 may be, for example, a photovoltaic cell such as a thin film amorphous silicon photovoltaic cell. Any other suitable device or structure for capturing energy may also be used. In one aspect of the present invention, energy capturing insert 108 is positioned in looped fiber cable 111 such that insert 108 is impacted by skew rays present in the fiber core 102. It is contemplated, however, that, an insert 108 may be positioned in any manner in fiber core 102 to be impacted by any light or wavelength energy traveling through core 102. As also shown in FIG. 1a, looped fiber cable 111 is provided in the form of a loop so that photon energy or other wavelength energy within cable 111 travels in a continuous, circuitous path. It is contemplated, however, that a straight fiber cable 114 may also be provided, as shown in FIG. 1b. Straight length of fiber cable 114 also includes at least one insert 108 positioned along a length thereof. Whether straight or looped, energy-capturing inserts 108 embedded in looped fiber cable 111 and straight fiber cable 114 have leads 112 extending therefrom. Any suitable energy-conducting lead including, for example, gold wire, may be used.

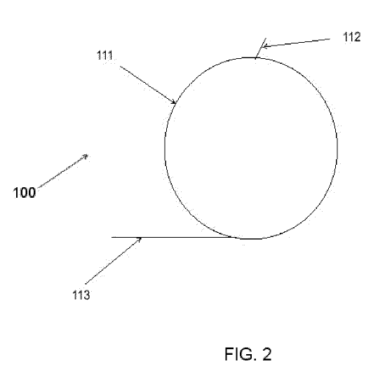

FIG. 2 is a schematic diagram depicting looped fiber cable 111 having an energy capturing insert 108 included therein, and also having a sealed fiber insert lead 113 included therewith. Fiber insert lead 113 is provided for insertion of light or wavelength energy into device 100 and contacts core 102 of looped fiber cable 111. Any suitable material may be used for the construction of fiber insert lead 113, and once light or wavelength energy is inserted into device 100 via fiber insert lead 113, the light or wavelength energy travels in a continuous, circuitous path around looped fiber cable 111, impacting one or more energy-capturing inserts 108 as it travels.

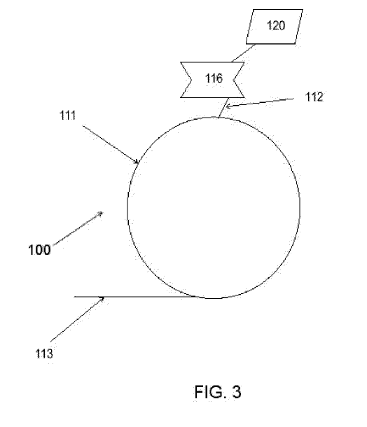

FIG. 3 is a schematic diagram depicting device 100 having an energy measuring device 116 attached via lead 112 to energy-capturing insert 108. Energy measuring device 116 may be any suitable device for measuring energy generated by insert 108, and various energy-measuring devices are known in the art. Box 120 represents recording instruments and controls in communication with energy measuring device 116, and again such instruments and controls are known in the art. Multiple energy measuring devices 116 may be associated with device 100 and attached to multiple energy-capturing inserts 108 via multiple leads 112.

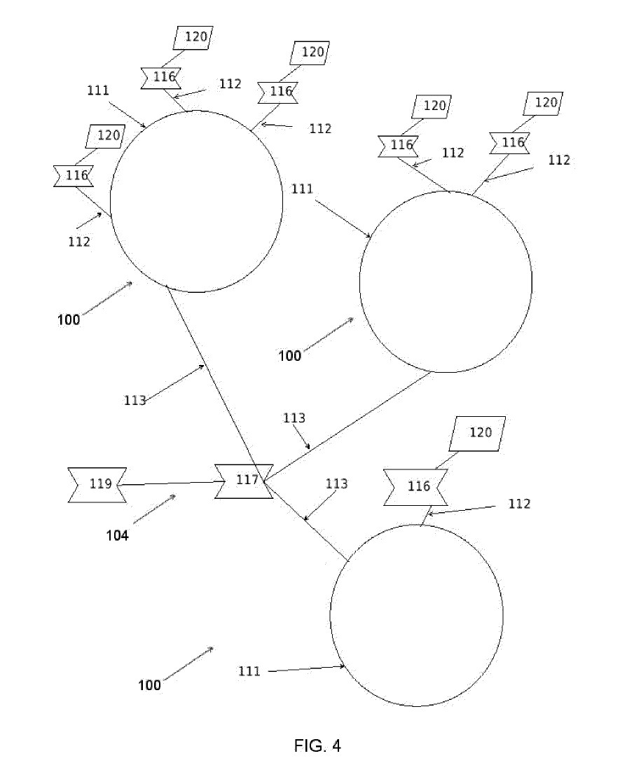

FIG. 4 is a schematic diagram illustrating a combination of three optical energy devices 100 of the present invention, with wavelength or light energy inserted into each of the three devices 100 by a single energy source, represented by box 119. The energy source represented by box 119 may be a laser, such as a 1 watt or lower energy laser, or any other suitable energy source. As light or wavelength energy travels from energy source 119 along insertion lead 104, the light or energy contacts a splitter 117 and is split along three separate paths, indicated by three sealed fiber insert leads 113. Each fiber insert lead 113 is affixed to a cable 111 of a different device 100, contacting the core thereof. Thus, light or wavelength energy from a single source is able to simultaneously provide energy into multiple devices 100. Although three devices 100 are shown in the figure, it is contemplated that two devices 100, or more than three devices 100, may be used in conjunction with the splitter configuration described here.

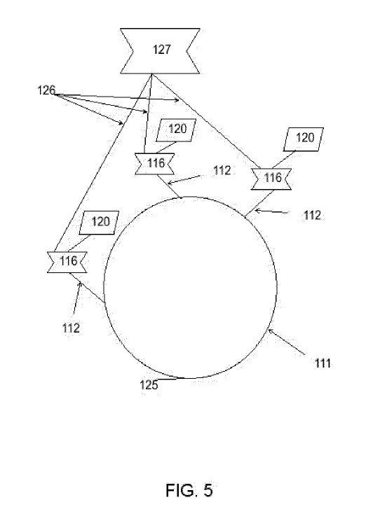

FIG. 5 is a schematic diagram illustrating a device 100 of the present invention having the various features and components described above, wherein energy produced by device 100 is directed toward one or more devices capable of receiving the energy, or into a device for energy storage. Box 127 represents one or more devices capable of receiving energy from one or more devices 100. These devices capable of receiving energy include, but are not limited to, commercial and residential lighting, consumer electronics, industrial and military electronics, devices for recharging batteries, or any other device requiring an external energy source. Lead lines 112 extend from multiple energy-capturing inserts 108, and each lead line 112 connects to an energy measuring device 116. Extending from energy measuring devices 116, and in communication with lead lines 112, lead lines 126 converge on one or more devices capable of receiving energy, as depicted by box 127. Lead lines 126 may be constructed from gold wires, but are not limited to that material. It is contemplated that energy measuring devices 116 may be removed from the path of the energy flow from device 100 to one or more devices capable of receiving energy, in which case energy is provided to the devices capable of receiving energy directly from one or more devices 100.

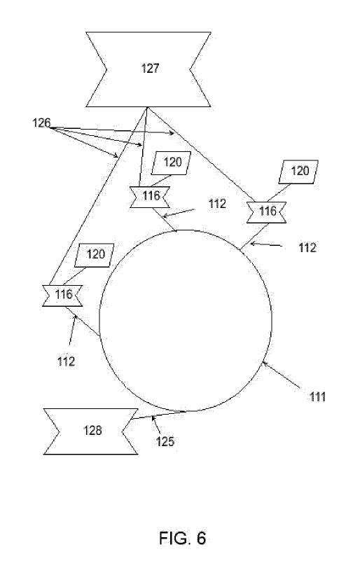

FIG. 6 is a schematic diagram as shown in FIG. 5, wherein also shown is box 128, representing an energy source such as a low-power laser adapted to provide light or wavelength energy to device 100. This energy is transmitted into device 100 via sealed insert fiber 125. In some embodiments of the present invention, the energy source may be powered, in part, by device 100, with a lead 112 extending from device 100 to the energy producing device. Thus, while the embodiment of device 100 in FIG. 5 is sealed and providing energy to a device capable of receiving the energy, the embodiment shown in FIG. 6 is also receiving energy from an energy source.

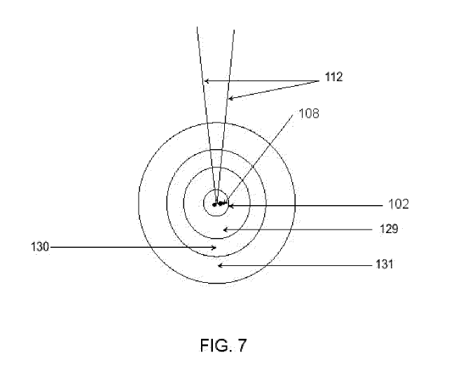

FIG. 7 is a schematic diagram depicting a cross-sectional view of an optical energy device 100 of the present invention. As can be seen in the figure, a looped fiber cable 111 includes an energy-capturing insert 108 embedded therein. Lead lines 112 extend away from energy-capturing insert 108, through the structure of device 100. As shown in FIG. 6, looped fiber cable 111 includes a core 102 surrounded by a cladding 129. The cladding has a refractive index lower than that of core 102, having one-hundred percent internal polarization such that light impacting the cladding is reflected back into the core. Also shown in FIG. 6 is a buffer or overcoating 130, which is preferably thermoplastic in nature, which surrounds cladding 129. An additional coating 131 may also be provided to add strength or provide other protection to device 100. Coating 131 may, for example, include Kevlar®. Also shown present in core 102 are two energy-capturing inserts 108 having leads 112 extending therefrom. Energy-capturing inserts 108 are not shown to relative scale in the drawings. It is contemplated that energy-capturing inserts 108 are typically of a size measure in tens of microns, and thus many such inserts may be present along the length of a core 102 of a single fiber cable 111 or 114. In one aspect of the invention, energy inserts 108 have a circumference smaller than that of the fiber core 102 so that light or wavelength energy that does not impact insert 108 is able to make another pass along the fiber loop.

As described above, device 100 is constructed from a length of fiber cable that may be present in a continuous loop or as a straight length of fiber cable. Because of the qualities of fiber cable and the path of light or wavelength energy passing therethrough, any shape of the length of fiber optic cable will be suitable. An exemplary method of making a device 100 of the present invention is now provided. In the following example, fiber cable 111 is a fiber optic cable, the structure of which is generally known in the art. It is contemplated that other fiber cables, such as, for example, plastic fiber, may also be utilized.

A segment of cladding (and any other layer between the outside of the cable and the core) is stripped from the fiber optic cable to expose the fiber core. A small slot such as, for example, a 40 micron slot, is cut into the core of the fiber optic cable for insertion of an energy-capturing insert 108 therein. Energy-capturing insert 108 may be, for example, a 30 micron thick photovoltaic cell. Energy-capturing insert 108 includes a lead 112 constructed from gold wire or other suitable material extending away therefrom. Once energy-capturing insert 108 with lead 112 is in place, the fiber optic cable is sealed by, for example, sputter coating. Alternatively, prior to sealing the area around the inserted energy-capturing insert may be filled with a substance that preserves to the extent possible the refractive index of the fiber optic core, allowing energy to travel more easily to the boundary of energy-capturing insert 108. After sealing, lead 112 protrudes from device 100 and may be used to extract energy therefrom.

Devices 100 may also be constructed with careful measurements being made during the process in order to ensure that energy has been provided to and retained by devices 100, and in order to determine amount of energy generation, leakage, and the like. For example, a section of cladding of fiber cable 111 or 114 may be stripped to expose the core 102 of the cable. At this point, measurements may be taken using precision patch cords of the insertion loss from the laser or other energy source directing energy into device 100. Once this measurement has been made, a suitably-sized slot (such as, for example, a 40 micron slot) is cut into the fiber, the slot having smooth sidewalls. The post-cut insertion loss of the slot is then measured, using both dry measuring methods as well as by filling the slot with a fluid having a refractive index that matches that of core 102. Once these measurements are complete, the slot is prepared for insertion of electrical contacts (such as, for example, gold contacts), as well as an energy-capturing insert 108.

A lead extending from insert 108 may then be used to measure energy generated by insert 108. This energy may be measured by any suitable device including, but not limited to, an energy meter or spectrometer. Once these readings have been taken, a sputter coating is applied by a coating device while light or other wavelength energy is still being inserted into device 100. This coating may be applied in a vacuum. Applying the sputter coating while energy is still being directed into device 100 ensures that energy loss during the sealing process is minimized. After the coating has been applied and device 100 is sealed, device 100 is ready for use.

Insertion of light or wavelength energy into device 100 along insert lead 113 preferably occurs simultaneously or near-simultaneously with sealing to minimize energy loss during the insertion and sealing process. Device 100 may include multiple energy-capturing inserts 108, each included in device 100 by the method set forth above. Once device 100 is sealed, the device is ready to provide for the energy needs of a user.

It is contemplated that multiple devices 100 may be used to power a single device capable of receiving energy, or that a single device 100 may be used to power multiple such receiving devices. It is further contemplated that a device 100 may be utilized as a measuring tool for measuring energy produced by nano-photovoltaic inserts.

From the above description of preferred embodiments of the invention, those skilled in the art will perceive improvements, changes and modifications. Such improvements, changes and modifications within the skill of the art are intended to be covered by the appended claims.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

Having described at least one preferred embodiment of the invention, what is claimed is:

1. An optical device for producing and storing energy comprising:
a core having a first refractive index;
a cladding surrounding said core and having a second refractive index, the second refractive index being lower than the first refractive index; and
at least one energy-capturing insert embedded in said core for capturing energy from the impact thereon of photons traveling through said core.

2. A optical device for producing and storing energy comprising:
at least one fiber cable; and
at least one energy-capturing insert embedded in a core of said fiber cable for capturing energy from the impact thereon of photons traveling through said fiber cable.

3. The optical device of claim 1, wherein the energy-capturing insert is a photovoltaic cell.

4. The optical device of claim 2, wherein the energy-capturing insert is a photovoltaic cell.

5. The optical device of claim 3, wherein the photovoltaic cell is a thin film amorphous silicon photovoltaic cell.

6. The optical device of claim 4, wherein the photovoltaic cell is a thin film amorphous silicon photovoltaic cell.

7. The optical device of claim 1, wherein the core is comprised of substantially pure silica.

8. The optical device of claim 1, further comprising a coating surrounding said cladding for protecting said optical device.

9. The optical device of claim 1, further comprising a lead extending from said energy-capturing insert to an exterior of said optical device for transmitting energy from said optical device to an energy-receiving device.

10. The optical device of claim 1, further comprising a sealed fiber insert extending to said core for introducing wavelength energy into said device.

11. The optical device of claim 2, wherein said fiber cable is a fiber optic cable.

12. The optical device of claim 2, wherein said cable is a plastic fiber cable.

13. A method of producing and storing energy comprising the steps of:
a) providing a fiber cable adapted to receive wavelength energy therein;
b) providing within said fiber cable at least one energy-capturing insert adapted to produce electrical energy when impacted by wavelength energy; and
c) introducing into said fiber cable wavelength energy from an energy source.

14. The method of claim 13 further comprising the steps of:
d) providing a lead extending from said at least one energy-capturing device to an exterior of said fiber cable, said lead being adapted to transmit electrical energy away from said at least one energy-capturing device; and
e) directing electrical energy from said lead to a device capable of receiving said electrical energy.

15. The method of claim 13 wherein said fiber cable is selected from the group consisting of fiber optic cables and plastic fiber cables.

16. The method of claim 14 wherein said fiber cable is selected from the group consisting of fiber optic cables and plastic fiber cables.
